(19) United States
(12) Patent Application Publication
(10) Pub. No.: US 2017/0138869 A1
(43) Pub. Date: May 18, 2017

(54) TWO-DIMENSIONAL RADIO-FREQUENCY CHEMICAL SENSOR

(71) Applicant: Wright State University, Dayton, OH (US)

(72) Inventors: Yan Zhuang, Dayton, OH (US); Hong Huang, Dayton, OH (US); Kathleen Brockdorf, Beavercreek, OH (US); Joshua Myers, Dayton, OH (US)

(21) Appl. No.: 15/353,027

(22) Filed: Nov. 16, 2016

Related U.S. Application Data
(60) Provisional application No. 62/296,127, filed on Feb. 17, 2016.
(60) Provisional application No. 62/255,787, filed on Nov. 16, 2015.

(51) Int. Cl. G01N 22/00

(52) U.S. Cl. CPC G01N 22/00

(57) ABSTRACT

A radio frequency two-dimensional chemical sensor is provided. In one embodiment, the sensor includes a transmission line. The transmission line may be modified to a more capacitive structure depending on the desired chemical to be sensed. In another embodiment, two of the sensors are provided on the surface of a dielectric material and are electrically connected via a Wilkinson power divider to improve the sensitivity of the device. The sensor provides both high selectivity and sensitivity to potentially toxic chemical compounds in the ppb and sub-ppb range in real world environments.

### CROSS REFERENCE TO RELATED APPLICATIONS

This application claims the benefit of U.S. Provisional Application No. 62/255,787, entitled TWO-DIMENSIONAL RADIO-FREQUENCY CHEMICAL SENSOR, filed Nov. 16, 2015, and also claims the benefit of U.S. Provisional Application No. 62/296,127, entitled TWO-DIMENSIONAL RADIO-FREQUENCY CHEMICAL SENSOR, filed Feb. 17, 2016. The entire contents of said applications are hereby incorporated by reference.

The technology disclosed herein was in part derived from a research project supported by the United States government under contracts FA85650-14-M-5076 and FA8650-15-C-5096 awarded by the Chemical and Biological Defense Program Small Business Innovation and Research Program of the Department of Defense. The government may have certain rights in the invention disclosed herein.

### BACKGROUND

The present invention relates to the fields of nanotechnology and radio frequency sensors, and more particularly to chemically-sensitive two-dimensional materials for detecting ultra-low concentrations of chemical compounds including, for example, potentially toxic compounds.

There are many types of chemical sensors to detect gases and liquids. Such chemical sensors range from chemically-sensitive field effect transistors (chemFET) to microelectromechanical systems (MEMS) cantilever devices.

Recently, efforts have been made to incorporate two-dimensional (2D) materials into such sensors. 2D materials are crystalline materials consisting of a single layer of atoms. Such 2D materials can be based on carbon, such as, for example, graphene, or other elements such as boron, germanium, silicon, or phosphorus, or compounds such as molybdenum sulfide.

Graphene is a thin layer of pure carbon. It is a single, tightly packed layer of carbon atoms that are bonded together in a hexagonal honeycomb lattice so thin that is it considered to be a two-dimensional (2D) material. Studies have demonstrated that graphene has remarkable electrical properties in addition to its ability to readily adsorb materials. Graphene has extremely high carrier mobility (200,000 cm²/V/s), and the large planar surface of graphene films readily adsorbs chemical compounds. Once adsorbed, these materials change the electrical properties of graphene. Measurement of the changes in electrical properties enable the use of graphene as a chemical sensor. Other 2D materials may also be candidates for use as chemical sensors.

Previous chemical sensor work with graphene used the material either as a resistor in a DC circuit, or alternately as a transistor. The literature has reported that graphene transistors can sense concentrations of as little as 28 ppb and 5 ppb of ammonia and dimethyl methylphosphonate (DMMP), respectively. These results, however, have only been demonstrated in an artificial environment of dry air and the sensing agent. However, real-world environments are much more complex than a controlled laboratory setting, and the levels of sensitivity of such direct current resistance and transistor-based sensors have not been demonstrated in real-world environments.

It would be desirable to be able to provide early warnings of the presence of even trace amounts of potentially toxic chemicals in the environment. Ammonia is considered a highly hazardous chemical because of its corrosive effects on the eyes, skin, and lungs in only parts per million (ppm) concentration levels. DMMP is a widely used simulant for Sarin gas, an organophosphorous-based nerve agent which is deadly at even very low concentrations. Currently existing gas sensors are not capable of providing parts per billion (ppb) or sub-ppb sensitivity for the detection of ammonia or DMMP in real-world environments.

Accordingly, there is still a need in the art for chemical sensors capable of sensitivities in the ppb and sub-ppb range when operated in real world environments.

### BRIEF SUMMARY

Embodiments of the 2D chemical sensors described herein have been demonstrated to maintain high selectivity and sensitivity to toxic chemical compounds in complex environments, including in the presence of water and other chemicals. The operation of the sensor differs from prior art graphene-based sensors in that it uses a radio frequency/microwave-based sensor, the properties of which change depending on the materials adsorbed onto the graphene surface. By “radio frequency” we mean frequencies in the range of from about 3 KHz to about 300 GHz, with microwave frequencies falling within the range of from about 300 MHZ to about 300 GHZ. Changes in electrical properties vary based on the type of chemical bond and the structure of the molecule which is adsorbed. Embodiments of sensors of the present invention have been demonstrated to possess selectivity and exceptional ultrahigh sensitivity, achieving sub-ppb sensitivities under ambient conditions.

In accordance with one embodiment of the present invention, a radio frequency two-dimensional chemical sensor is provided. In one embodiment, the sensor includes a transmission line. The transmission line may be modified to a more capacitive structure depending on the desired chemical to be sensed. In another embodiment, two of the sensors are provided on the surface of a dielectric material and are electrically connected via a Wilkinson power divider to improve the sensitivity of the device. In some embodiments, the sensors are graphene-based. In other embodiments, other 2D materials may be utilized for the sensors.

In accordance with another embodiment, a two-dimensional radio frequency sensor comprising first and second monomolecular layers on a dielectric substrate is provided. The first and second monomolecular layers are separated from one another, with the first monomolecular layer being exposed to the environment and the second monomolecular layer being sealed from the environment. The first and second monomolecular layers are comprised of a material which adsorbs chemical compounds. The device also includes a source of radio frequency signals, electrical connectors connecting each of the first and second monomolecular layers to the source of radio frequency signals, and a device for measuring the change in electrical properties of the first sensor upon exposure to the environment.

In yet another embodiment, a two-dimensional radio frequency chemical sensor comprising a first sensor and a second sensor is provided. The first sensor is exposed to the environment, and the second reference sensor is sealed from exposure to the environment. The device also includes a source of radio frequency signals, a divider for dividing the source of radio frequency signals into first and second signals of equal strength, electrical connectors for connecting each of the first and second signals to respective first and second sensors, and a circulator for combining the signals from the first sensor and second reference sensor while removing environmental noise and the reference signal.

In some embodiments, each of the first sensor and second sensors comprise a monomolecular layer of a material selected from the group consisting of carbon, boron, germanium, silicon, or phosphorus on a dielectric substrate. In other embodiments, each of the first sensor and second sensors comprise a monomolecular layer of graphene on a dielectric substrate.

In some embodiments, the surface of the graphene can be functionalized to enhance its sensitivity to a chemical compound of interest. In some embodiments, the first and second sensors comprise distributed capacitors. In one form, the distributed capacitors comprise a series of interdigitated conductive fingers, each finger having a width of from between about 3 to about 10 microns.

In another embodiment of the invention, a method of making a two-dimensional radio frequency chemical sensor is provided and comprises forming a monomolecular layer of graphene on a major surface of a dielectric substrate; patterning the layer of graphene to form first and second sensing regions on the substrate; forming a pattern for a Wilkinson power divider, and forming electrical contacts connecting the power divider to the first and second sensing regions; and hermetically sealing the second sensing region from the environment.

In another embodiment, a method for detecting the presence of ultra-low concentrations of chemical compounds in the environment is provided and comprises providing radio frequency signals of equal strength to first and second chemical sensors; exposing the first chemical sensor to an environment containing an ultra-low concentration of a chemical compound of interest while the second reference sensor is hermetically sealed from exposure to said environment; combining the signals from the first sensor and second reference sensor while removing environmental noise and the reference signal; and measuring the change in the resulting electric signal strength as a function of the concentration of the chemical compound of interest.

In some embodiments, the chemical compound of interest comprises ammonia. In other embodiments, the chemical compound of interest comprises dimethyl methylphosphonate.

In some embodiments, the environment is a gaseous environment. In other embodiments, the environment is a liquid environment.

In some embodiments, a Wilkinson power divider provides the radio frequency signals of equal strength to first and second chemical sensors.

Accordingly, it is a feature of the present invention to provide a chemical sensor which exhibits both high selectivity and sensitivity to potentially toxic chemical compounds in the ppb and sub-ppb range in real world environments. Other features and advantages of the present invention will be apparent from the following detailed description, the accompanying drawings, and the appended claims.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a chart depicting changes in electrical resistivity (Δρ/φ of graphene over time (sec), with region I depicting the graphene sensor in a vacuum, region II depicting exposure of the graphene sensor to diluted chemicals, region III depicting evacuation of the sensor, and region IV depicting annealing of the sensor at 150° C.; the inset depicts an optical micrograph of the graphene sensor;

FIG. 2 is a schematic side view of one embodiment of the graphene-impedance based sensor, depicting a pair of sensors in parallel and separated by a 180° hybrid to cancel the input signal and noise experienced by the two sensors;

FIG. 3 depicts a schematic side view of another embodiment of a single sensing structure;

FIG. 4 is a schematic side view of a step in the fabrication of an embodiment of the sensor;

FIG. 5 is a schematic side view of a step in the fabrication of an embodiment of the sensor;

FIG. 6 is a schematic side view of a step in the fabrication of an embodiment of the sensor;

FIG. 7 is a schematic side view of a step in the fabrication of an embodiment of the sensor;

FIG. 8 is a schematic side view of a step in the fabrication of an embodiment of the sensor;

FIG. 9 is a schematic side view of a step in the fabrication of an embodiment of the sensor;

FIG. 10 is a schematic side view of a step in the fabrication of an embodiment of the sensor;

FIG. 11 is a schematic side view of a step in the fabrication of an embodiment of the sensor;

FIG. 12 is a schematic side view of a step in the fabrication of an embodiment of the sensor;

FIG. 13 is a schematic side view of a step in the fabrication of an embodiment of the sensor;

FIG. 14 is a schematic side view of a step in the fabrication of an embodiment of the sensor;

FIG. 15 is a schematic side view of a step in the fabrication of an embodiment of the sensor;

FIGS. 16 (a), (b), and (c) are graphs of RF/microwave impedance sensing results of one embodiment of the sensor when exposed to ammonia vapor;

FIGS. 17 (a), and (b) are graphs of RF/microwave impedance sensing results of one embodiment of the sensor when exposed to DMMP vapor; and

FIG. 18. Is a schematic side view of another embodiment of the 2D impedance-based sensor, depicting a Wilkinson power divider circuit sending input signals to identical chemical sensors.

FIG. 19(a) is a graph comparing ΔS₁₁ for a sensor exposed to ammonia and DMMP, with a projected sensitivity of 6 parts per trillion (ppt) for ammonia and 80 ppt for DMMP.

FIG. 19(b) is a graph depicting the selectivity of a sensor when operating in environments containing 12 vol. % water, 55 vol. % methanol, and 23 vol. % isopropanol, respectively.

### DETAILED DESCRIPTION

Several embodiments of the invention are described in detail below, including exemplary embodiments using graphene as the 2D material. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the invention. For example, other 2D materials may be utilized in the sensor depending on the chemical to be sensed.

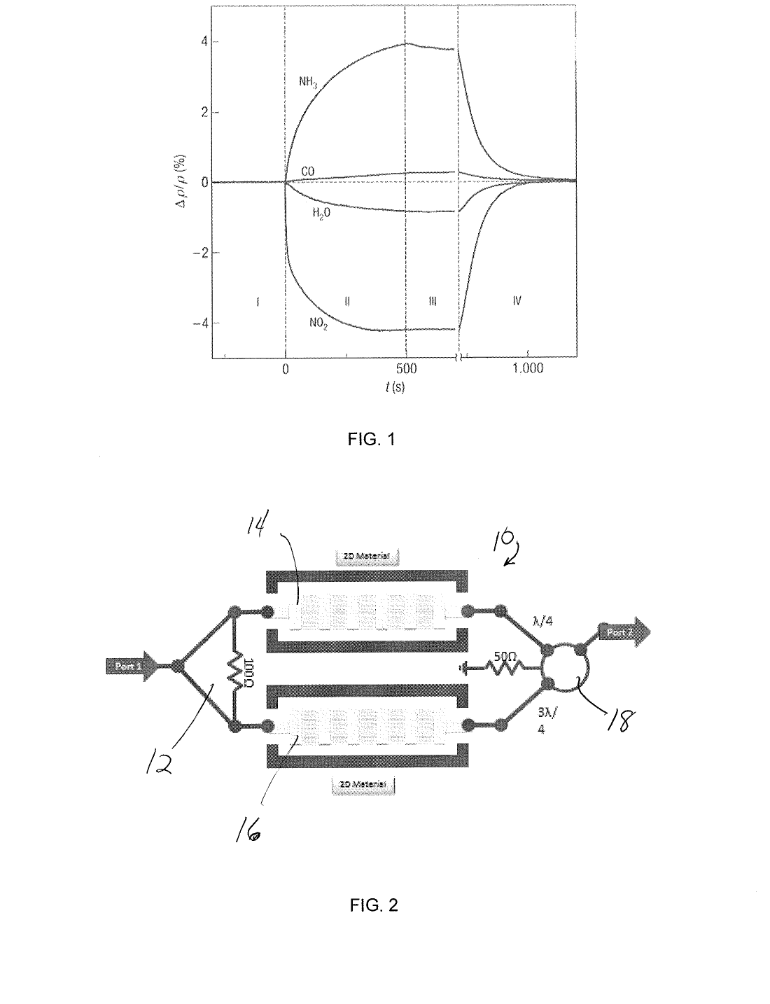

FIG. 1, is a chart reproduced from Hu et al., Carbon Nanostructure-Based Field-Effect Transistors for Label-Free Chemical/Biological Sensors, Sensors (2010), 10, 5133-5159. The chart depicts changes in electrical resistivity (Δρ/φ of graphene over time (sec) with exposure to 1 ppm concentrations of NH₃, CO, H₂O, and NO₂, respectively, with region I depicting the graphene sensor in a vacuum, region II depicting exposure of the graphene sensor to diluted chemicals, region III depicting evacuation of the sensor, and region IV depicting annealing of the sensor at 150° C. The inset depicts an optical micrograph of the graphene sensor.

With reference to FIG. 2, one embodiment of the sensor construction is shown. In this embodiment, input to sensor 10 is provided through Port 1. An RF/microwave signal is fed to the sensor, and the signal is split using a Wilkinson power divider, generally shown at 12. A Wilkinson power divider circuit uses quarter wave transformers to achieve isolation between electrical outputs. As shown, the RF/microwave input feed is divided equally and sent to two identical chemical sensors 14 and 16.

The construction details of those sensors are described in greater detail below. One of the sensors is exposed to the environment containing the chemical to be sensed, while the other sensor is placed in a hermetically sealed environment to provide a stable reference signal. The exposed sensor may be positioned to sense the presence of toxic compounds in either a gaseous or liquid environment. The outputs from the two sensors are then combined with a 180° phase shift using a circulator 18 as shown. The circulator is a passive, non-reciprocal three or four port device in which a radio frequency or microwave signal entering the circulator is transmitted to the next port in rotation only. The circulator 18 removes any environmental noise as well the reference signal. The remaining output signal from Port 2 is then examined for the presence of a chemical to be sensed.

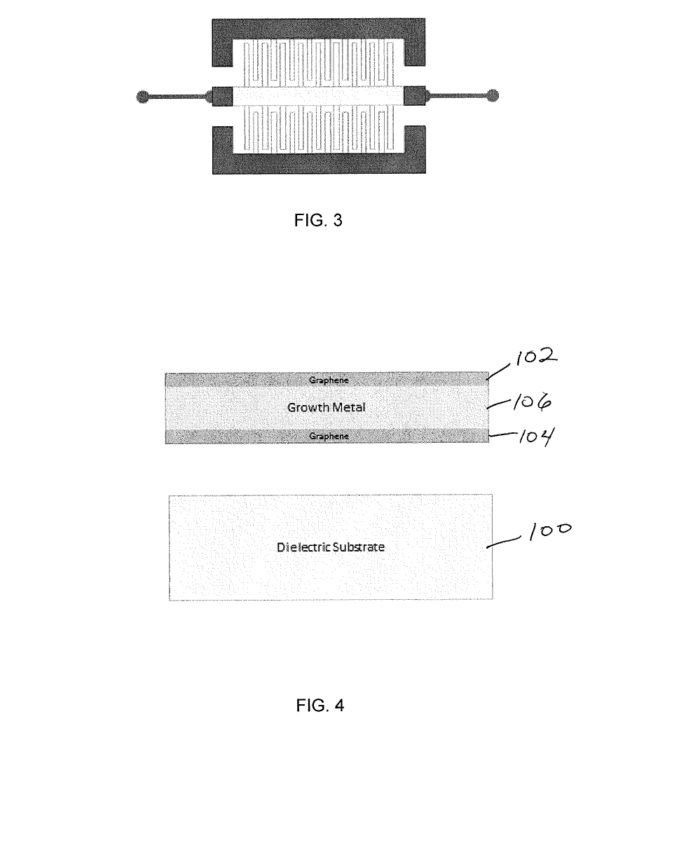

With reference to FIG. 3, another embodiment of the sensor is shown. In this embodiment, an interdigitated sensor structure is substituted for the sensor structure shown in FIG. 2. As shown, the sensor is in the form of a distributed capacitor, where capacitance is between adjacent conductive “fingers” in the sensor structure. Generally, the width of each “finger” is from between about 3 to about 10μ. This construction permits operation of the sensor device at lower frequencies, such as, for example, in the 2-4 GHz range.

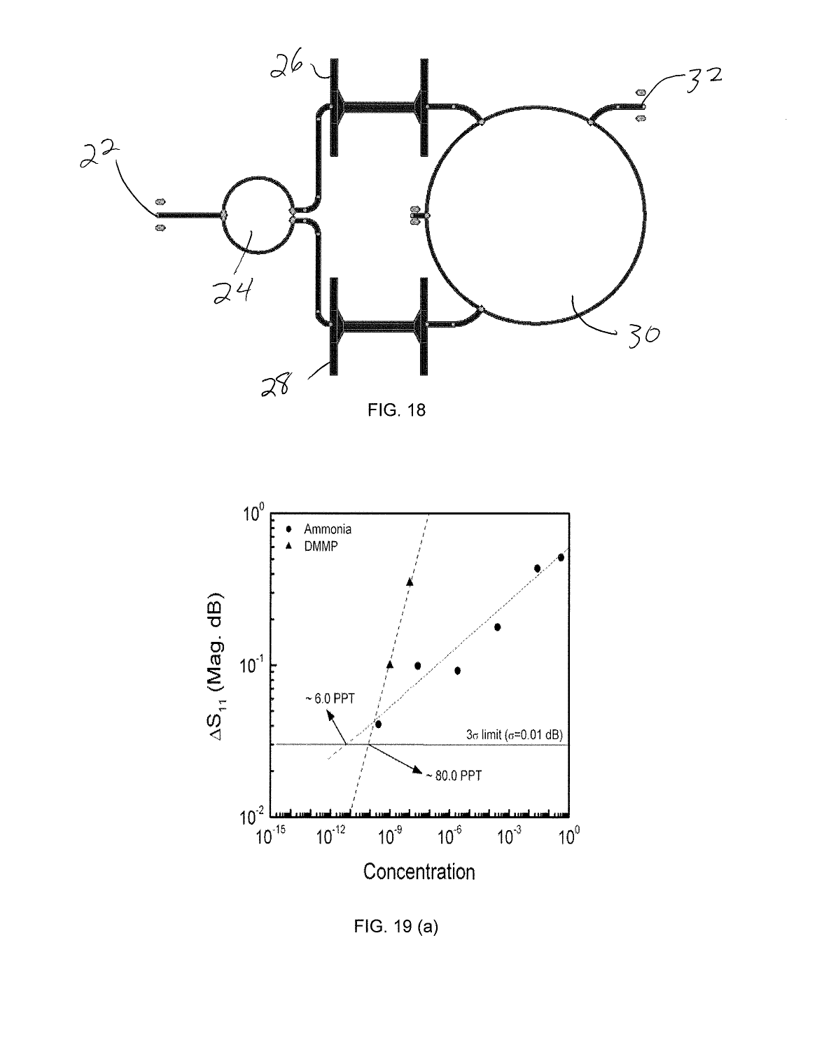

With reference to FIG. 18, another embodiment of the sensor similar in construction and operation to the FIG. 2 embodiment is shown. An RF/microwave signal is fed through input port 20 to the sensor, and the signal is split using a Wilkinson power divider circuit 24. As shown the input signal is divided equally and sent to two identical chemical sensors 26 and 28. Again, the construction details of the sensors are described in greater detail below. One of the sensors is exposed to an environment containing a chemical to be sensed, while the other sensor is placed in a hermetically sealed environment to provide a stable reference signal. The exposed sensor may be placed in either a gaseous or liquid environment, depending on the desired chemical to be sensed. Additionally, the surface of the graphene may be functionalized to enhance the sensitivity of the sensor to a chemical compound or compounds of interest.

The outputs from the two sensors are then combined with a 180° phase shift using a circulator 30 as shown. The circulator 30 removes any environmental noise as well the reference signal. The remaining output signal from port 32 is then examined for the presence of a chemical to be sensed.

With reference to FIGS. 4-15, one embodiment of the RF/microwave chemical sensor may be fabricated as follows. FIG. 4 depicts the first step in the fabrication process using graphene as the 2D material. A dielectric substrate 100 such as a silicon wafer, or a silicon wafer having a thermal SiO₂ formed on the surface of the wafer, is cleaned using a combination of chemical solvents as is conventional in the art. The wafer is rendered hydrophilic by exposure to an oxygen plasma etch. This preparation enhances the adhesion of the graphene to the dielectric substrate. Separately, as also shown in FIG. 4, single molecular layers 102 and 104 of graphene, the 2D material used in this embodiment, are deposited and/or grown on both sides of a metal foil substrate 106 such as copper. One method of forming graphene layers is by using a chemical vapor deposition (CVD) process to deposit a precursor, followed by pyrolysis of the precursor.

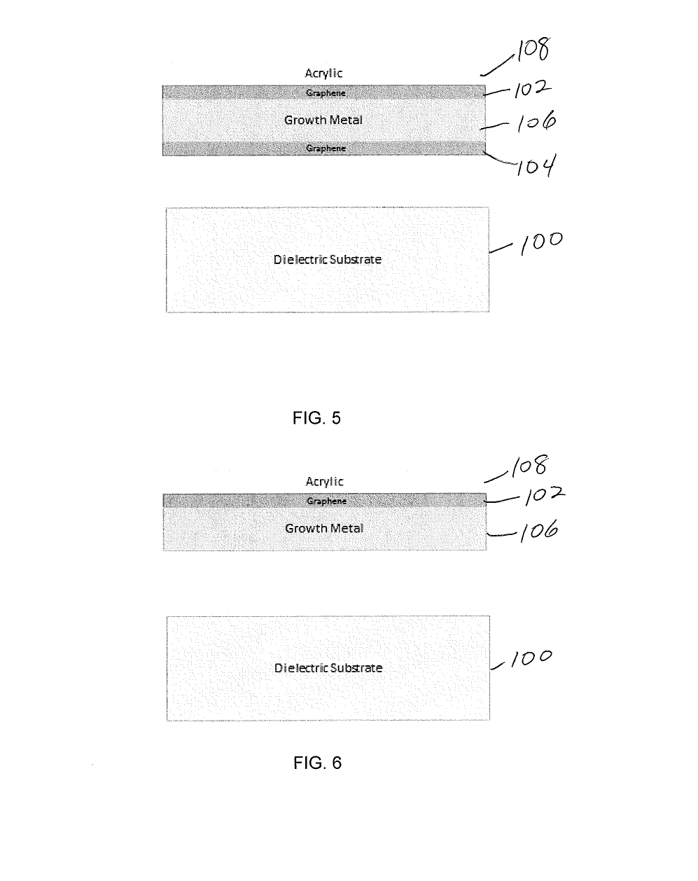

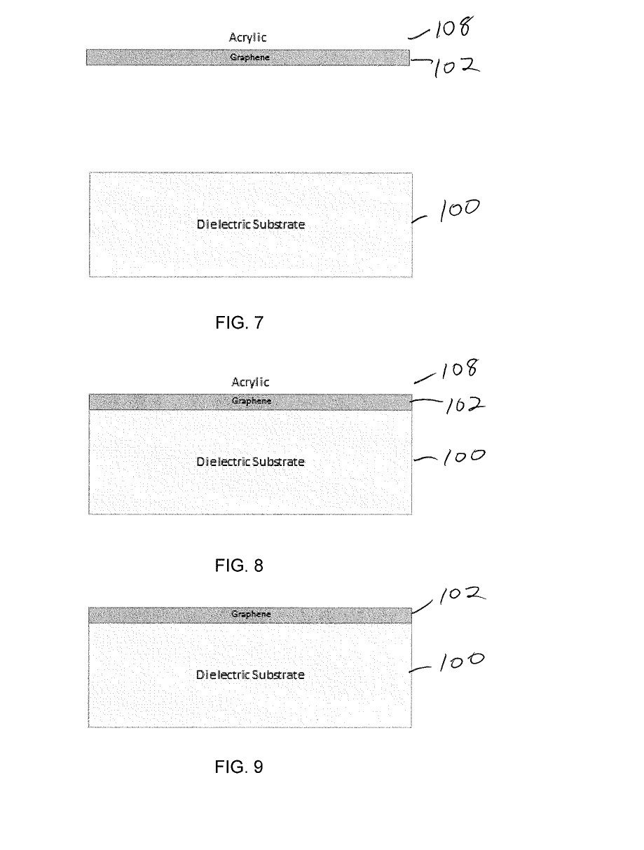

The next step in the fabrication process is shown in FIG. 5 where the graphene layer 102 on one side of the metal substrate 106 is coated with a layer of an acrylic polymer 108 such as polymethylmethacrylate to protect the graphene during the next steps of fabricating the sensor. The opposite side of the metal substrate 106 is etched using oxygen gas plasma to remove graphene layer 104 and etch the metal substrate as shown in FIG. 6. As shown in FIG. 7, the acrylic-protected graphene layer 102 backed by metal substrate 106 is then be placed in a chemical etchant solution to remove the metal. Once metal substrate 106 is removed, the graphene layer 102 may be cleaned in deionized water and transferred to dielectric substrate 100.

As shown in FIG. 8, the graphene layer 102 and dielectric substrate 100 are then baked at a high temperature to cause the graphene to adhere to the dielectric substrate. The acrylic layer 108 protecting the graphene is then removed using chemical solvents as shown in FIG. 9.

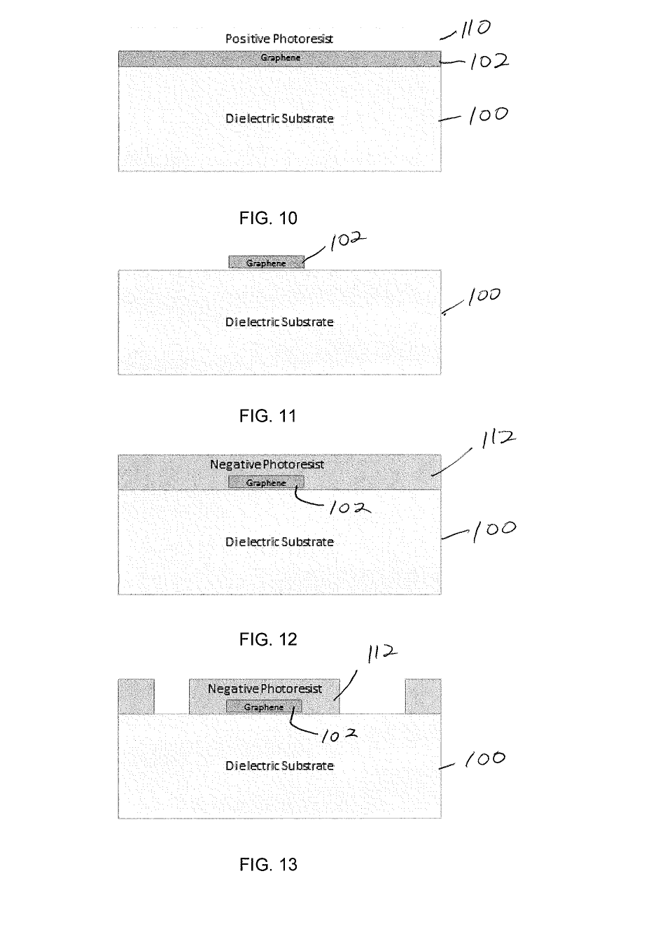

As shown in FIG. 10, a layer of a positive photoresist 110 may then be spun onto the graphene layer 102, and, as shown in FIG. 11, a graphene pattern for the sensor is formed. The sensing pattern provides two sensing regions (only one shown) and is an important component of the sensor device. The sensor can have multiple variants in structure depending on the chemical compound to be sensed. The mask which is used to form the pattern and sensing regions should provide a high level of resolution for device to device uniformity. As both sensing regions are patterned using the same mask, any differences between the two sensing regions is minimized.

For each compound to be sensed, an operating frequency is determined for the structure which determines the overall length of the device. The most basic design is a single transmission line, but, dependent on the characteristics needed, multiple transmission lines and capacitive lines may be incorporated into the sensor structure. These may either be interdigital regions to the ground or in-line capacitive regions. By tuning in this manner, a high degree of selectivity for the compound of interest is achieved, creating a unique device that possesses both high selectivity as well as high sensitivity.

As shown in FIG. 11, the patterned sensor device is then etched with an oxygen plasma to remove the excess graphene. The remaining photoresist is removed using conventional chemical solvents. As shown in FIGS. 12 and 13, a layer of a negative photoresist 112 is then applied to the dielectric substrate 100, and the patterns for the Wilkinson power divider, contacts to the sensing structures, and the hybrid structure are fabricated. The hybrid structure creates a 180° phase difference, allowing variations due to noise to be cancelled due to the matching structures. By cancelling background noise, an additional three orders of resolution over the individual sensor's ppb resolution can be achieved.

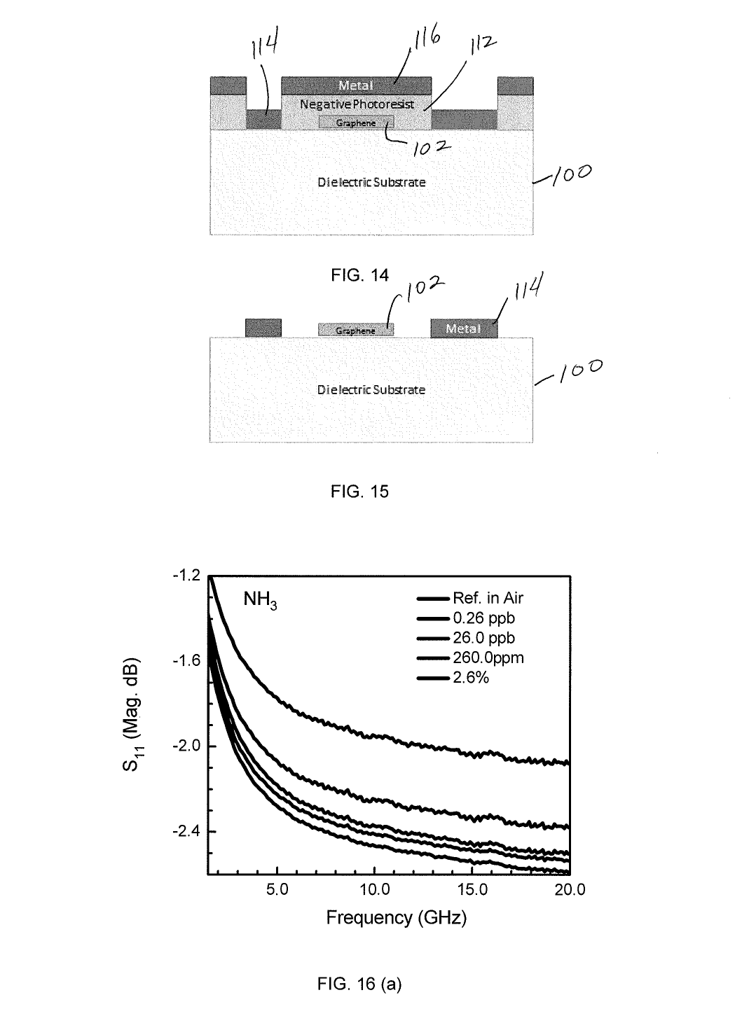

As shown in FIG. 14, a metal 114 having a high sticking coefficient such as chromium is evaporated, using a physical vapor deposition process (PVD), onto the dielectric substrate 100. A primary metal such as gold is then deposited onto the dielectric substrate. As shown in FIG. 15, excess material is then removed through liftoff by placing the entire structure into a chemical solvent. A resistor is then attached to the wafer to provide separation for the power divider. Finally one of the sensing regions which will act as a reference is hermetically sealed, either by a dielectric layer or a cap with an appropriate air gap.

The sensor device as described may be paired with multiple variants to create a more complete sensor for a variety of chemical agents, and also to reduce the possibility of error for a specific chemical. The output signal may be examined using digital signal processing. Because the sensor device operates using radio frequencies, the sensor may use both magnitude and phase in order to determine the type of device. Testing has shown that the type of chemical bonds found in the gases of interest have a strong effect on the phase, and the combination of the magnitude and phase may be used with the sensor to increase its selectivity for a compound of interest.

The design aspects of the sensor permit it to be modified as needed. However, to maintain selectivity and sensitivity of the device, the structure should maintain the same characteristic impedance as the input and output structures so as to avoid the need for a matching network. The design of the sensor may take into account the chemical to be sensed and the operating frequency determined based on the size limitations of the overall system (i.e., it must fit on one wafer or glass sheet) as well as the chemical resonances. In general, greater surface area and edges aid in creating a stronger signal, although the length of the transmission line should not be excessive. Including multiple transmission lines assists in tuning the characteristic impedance. In order to maintain a single path length, the input of the multiple transmission line is preferably located at one edge and the output at the opposite edge.

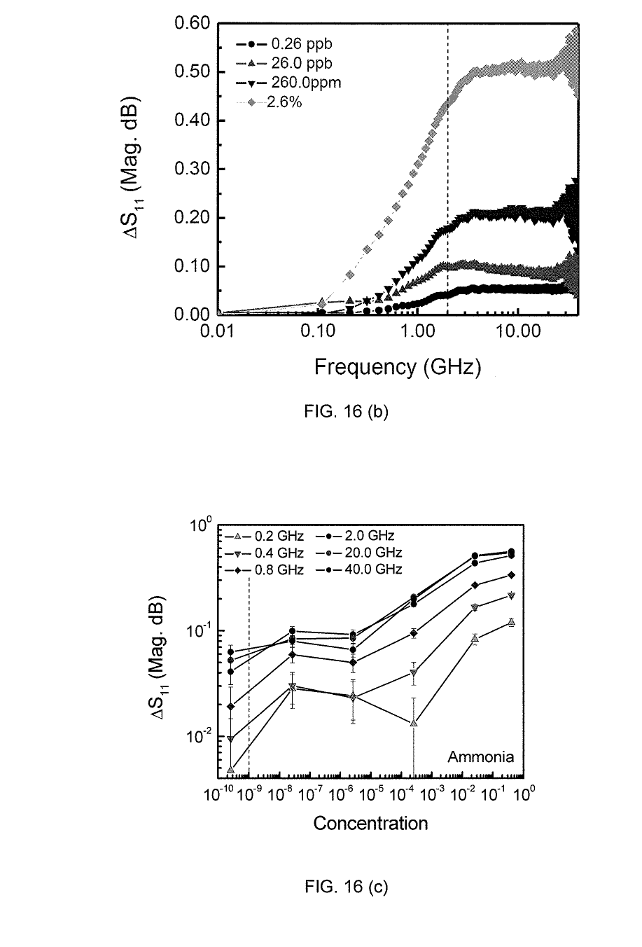

The graphs of FIGS. 16 (a), (b), and (c) show the RF/microwave impedance sensing results for one embodiment of the graphene-based gas sensor as exposed to ammonia vapor in humid air at concentrations ranging from 0 ppb (reference air only) to 2.6 vol. % NH₃. FIG. 16(a) depicts the measured change in magnitude in dB of S₁₁ versus frequency (in gigahertz), with the resulting curves, lowest to uppermost being reference air, 0.26 ppb, 2.6 ppb, 260 ppb, and 2.6 vol. %. S₁₁, a scattering parameter, is the ratio of forward and reverse voltage, essentially the reflection coefficient. While S₁₁ is a unitless number, it can be represented in decibels after a conversion as is known in the art. FIG. 16(b) depicts the difference in magnitude of S₁₁, ΔS₁₁, in humid air for ammonia concentrations ranging from 0.26 ppb to 2.6 vol. % versus frequency (in gigahertz) for a control. FIG. 16(c) depicts the difference in magnitude of S₁₁ versus ammonia concentration at different frequencies ranging from 0.2 GHz to 40.0 GHz. As can be seen, operation of the sensor at high frequencies reduced errors and uncertainties in the measurement of ammonia. As can also be seen, the sensitivity of the sensor (i.e., its ability to detect and measure) reached sub-ppb concentrations of ammonia in humid air.

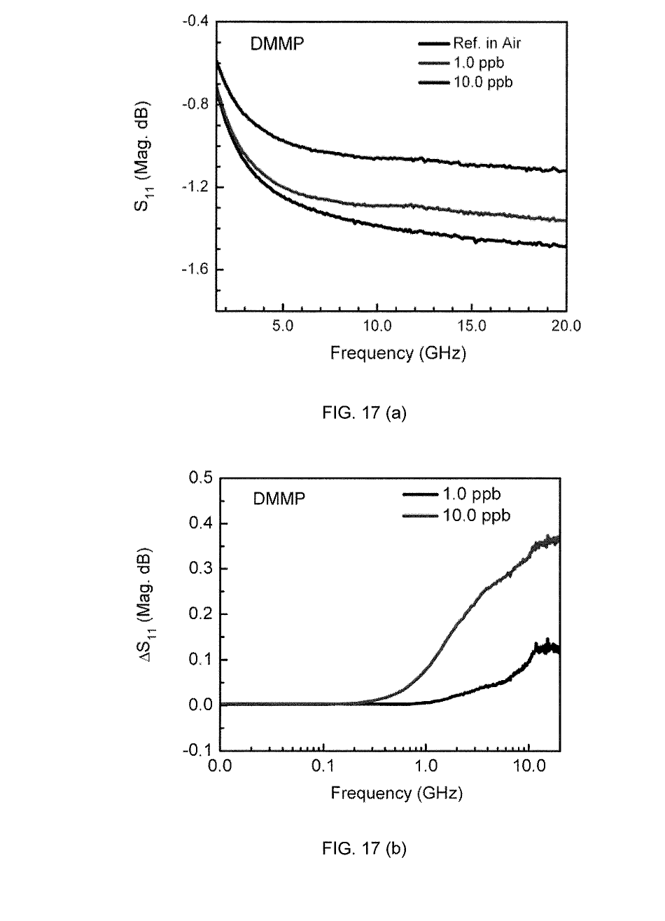

The graphs of FIGS. 17(a) and (b) show the RF/microwave sensing results of one embodiment of the sensor when it is exposed to nitrogen gas containing DMMP vapor at 10.0 ppb (upper curve), 1.0 ppb (middle curve), and 0 ppb (reference air only; lower curve) concentrations, respectively. FIG. 17(a) depicts the magnitude of S₁₁ versus frequency (in gigahertz). FIG. 17(b) depicts the magnitude of the change in S₁₁, ΔS₁₁, versus frequency (in gigahertz). As can be seen, operating at RF and microwave frequencies, the sensor was able to detect and measure concentrations of DMMP at 10.0 ppb (upper curve) and as low as 1.0 ppb (lower curve).

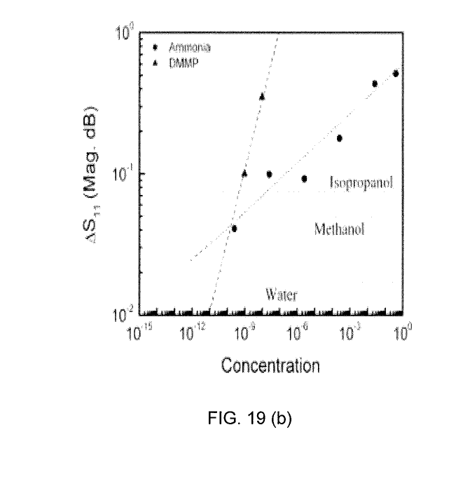

The graphs of FIGS. 19 (a) and (b) show the sensitivity and selectivity of one embodiment of the sensor operating in air environments containing additional chemical compounds. FIG. 19(a) compares ΔS₁₁ for a sensor exposed to ammonia and DMMP. The projected sensitivity of the sensor is 6 parts per trillion (ppt) for ammonia and 80 ppt for DMMP. FIG. 19(b) depicts the selectivity of the sensor when operating in environments containing 12 vol. % water, 55 vol. % methanol, and 23 vol. % isopropanol, respectively. As can be seen, the sensitivity and selectivity of the sensor was not affected by operation in these environments.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Unless the meaning is clearly to the contrary, all ranges set forth herein are deemed to be inclusive of all values within the recited range as well as the endpoints.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A two-dimensional radio frequency sensor comprising first and second monomolecular layers on a dielectric substrate, said first and second monomolecular layers being separated from one another, said first monomolecular layer being exposed to the environment and said second monomolecular layer being sealed from the environment, said first and second monomolecular layers being comprised of a material which adsorbs chemical compounds, a source of radio frequency signals, electrical connectors connecting each of said first and second monomolecular layers to said source of radio frequency signals, and a device for measuring the change in electrical properties of said first sensor upon exposure to the environment.

2. A two-dimensional radio frequency chemical sensor comprising a first sensor and a second sensor, the first sensor being exposed to the environment and the second reference sensor being sealed from exposure to the environment, a source of radio frequency signals, a divider for dividing the source of radio frequency signals into first and second signals of equal strength, electrical connectors for connecting each of the first and second signals to respective first and second sensors, and a circulator for combining the signals from the first sensor and second reference sensor while removing environmental noise and the reference signal.

3. A two-dimensional radio frequency chemical sensor as claimed in claim 2 in which each of said first sensor and second sensors comprise a monomolecular layer of a material selected from the group consisting of carbon, boron, germanium, silicon, or phosphorus on a dielectric substrate.

4. A two-dimensional radio frequency chemical sensor as claimed in claim 2 in which each of said first sensor and second sensors comprise a monomolecular layer of graphene on a dielectric substrate.

5. A two-dimensional radio frequency chemical sensor as claimed in claim 4 in which the surface of the graphene has been functionalized to enhance its sensitivity to a chemical compound of interest.

6. A two-dimensional radio frequency chemical sensor as claimed in claim 2 in which said first and second sensors comprise distributed capacitors.

7. A two-dimensional radio frequency chemical sensor as claimed in claim 6 in which said distributed capacitors comprise a series of interdigitated conductive fingers, each finger having a width of from between about 3 to about 10 microns.

8. A method of making a two-dimensional radio frequency chemical sensor comprising:
forming a monomolecular layer of graphene on a major surface of a dielectric substrate;
patterning said layer of graphene to form first and second sensing regions on said substrate;
forming a pattern for a Wilkinson power divider and forming electrical contacts connecting said power divider to said first and second sensing regions; and
hermetically sealing said second sensing region from the environment.

9. A method for detecting the presence of ultra-low concentrations of chemical compounds in the environment comprising:
providing radio frequency signals of equal strength to first and second chemical sensors;
exposing said first chemical sensor to an environment containing an ultra-low concentration of a chemical compound of interest while said second reference sensor is hermetically sealed from exposure to said environment;
combining the signals from the first sensor and second reference sensor while removing environmental noise and the reference signal; and
measuring the change in the resulting electric signal strength as a function of the concentration of the chemical compound of interest.

10. A method as claimed in claim 9 wherein the chemical compound of interest comprises ammonia.

11. A method as claimed in claim 9 wherein the chemical compound of interest comprises dimethyl methylphosphonate.

12. A method as claimed in claim 9 wherein the environment is a gaseous environment.

13. A method as claimed in claim 9 wherein the environment is a liquid environment.

14. A method as claimed in claim 9 wherein a Wilkinson power divider provides said radio frequency signals of equal strength to first and second chemical sensors.
